(19) United States
(12) Patent Application Publication
(10) Pub. No.: US 2022/0399997 A1
(43) Pub. Date: Dec. 15, 2022

(54) PROCESS FOR ALLOWING A USER TO ACCESS A BLOCK CHAIN OF AN ORGANIZATION

(71) Applicant: BPCE, Paris (FR)

(72) Inventors: José Luu, Igny (FR); Cyril Vignet, Paris (FR)

(21) Appl. No.: 17/765,208

(22) PCT Filed: Sep. 29, 2020
(86) PCT No.: PCT/EP2020/077262

§ 371 Date: Mar. 30, 2022

(30) Foreign Application Priority Data
Sep. 30, 2019 (FR) FR1910815

(51) Int. Cl. H04L 9/08

(52) U.S. Cl. CPC H04L 9/0825; H04L 9/0861; H04L 9/0894

(57) ABSTRACT

The invention relates to a process for allowing a user to access a block chain of an organization the process providing for: generating a pair of private and public keys in order to allow the user to carry out cryptographic signatures during participation in an operational function in the block chain. The invention includes collecting personal data of the user, the data having an information item concerning the identity of the user and an information item concerning the organization. The invention also includes verifying the validity of the personal data, identifying a status of the user within the organization using verified data, and storing the public key in a digital safe of the block chain in accordance with the identified status in order to allow the user to participate in at least one operational function in the block chain which is accessible via the safe.

### CROSS-REFERENCE TO RELATED APPLICATIONS

This application claims the benefit of International application number PCT/EP2020/077262, filed Sep. 29, 2020 and French patent application number 1910815, filed on Sep. 30, 2019, the entire contents of which are incorporated herein by reference.

### TECHNICAL FIELD

The invention relates to a process for allowing a user to access a blockchain of an organization, as well as an architecture comprising means for the implementation of such a process.

### BACKGROUND

Blockchains are technologies that enable their users to store and transmit data in a secure manner and without any central control body, thanks to a distributed database whose information sent by the users and internal links are verified and grouped at regular time intervals in blocks, thereby forming a chain (see in particular the article “Blockchain” on the site of the collaborative encyclopedia Wikipedia® and the article of the online newspaper “Le Journal du Net” available at the address https://www.journaldunet.com/economie/finance/1195520-blockchain-avril-2019/).

This fast-growing technology is used in particular to enable the users to carry out transactions, validated by a consensus mechanism between nodes in the chain (called “miners”), and finds application more particularly in the creation and management of virtual currencies, or crypto-currencies, such as for example Bitcoin®, Ether®, Monero® or Peercoin® (or PPcoin®).

The use of a blockchain proves to be particularly advantageous for an organization, in particular a large company, in that it allows easily relating the different operational functions carried out within said organization, as well as the various managers benefiting from mandates within said organization to participate in these operational functions.

To grant access to the blockchain of the different members of the organization, the current systems are primarily based on a presumption of trust for standard commercial acts and, for more complex operational functions requiring the intervention of managers, a verification of the identity documents of said managers and of the official documents of the organization, for example a K-Bis excerpt.

This solution is not fully satisfactory, in that it does not allow carrying out in a fully secure manner a complex operational function, which requires in particular a guarantee of the identity of each of the participants, of their respective consent and of the security of the link between identity and the consent.

### SUMMARY OF THE INVENTION

The invention aims to improve the prior art by providing in particular a process for enabling an organization to easily manage its operational functions, for example its commercial interactions with external entities, by means of a blockchain, while guaranteeing to said organization optimum security with regards to the identity of the participants in said operational functions and to the consent of said participants.

To this end, according to a first aspect, the invention provides a process for allowing a user to access a blockchain of an organization, said process providing for:
generating a pair of private and public keys to allow said user to carry out cryptographic signatures during a participation in an operational function in the blockchain;
collecting personal data of the user, said data comprising at least one information item on the identity of the user and one information item on said organization;
verifying the validity of said personal data;
identifying a status of said user within said organization by means of said verified data;
registering the public key in at least one digital safe of the blockchain according to said identified status, in order to allow said user to participate in an operational function in said blockchain accessible via said safe.

According to a second aspect, the invention provides an architecture for allowing a user to access a blockchain of an organization, said architecture comprising:
an application installed on a terminal of said user, said application comprising means for generating a pair of private and public keys to allow said user to carry out cryptographic signatures during a participation in an operational function in the blockchain;
a platform for providing at least one digital safe allowing participation in an operational function in said blockchain;
a central platform comprising:
means for collecting the public key;
means for collecting personal data of a user, said data comprising at least one information item on the identity of the user and one information item on said organization;
means for verifying the validity of said personal data;
means for identifying a status of said user within said organization by means of said verified data;
means for registering the public key in at least one digital safe according to said identified status, in order to allow said user to participate in at least one operational function in said blockchain accessible via said safe.

### BRIEF DESCRIPTION OF THE DRAWING

Other particularities and advantages of the invention will appear in the following description, made with reference to the appended figures, wherein:

FIG. 1 represents an architecture for implementing a process according to an embodiment of the invention;

FIG. 2 represents the hierarchical organization of the users of the blockchain, as well as their accesses to the corresponding safes.

### DETAILED DESCRIPTION

Referring to these figures, a process is described below for allowing a user 1, 1a, 1b, 1c, 1d to access a blockchain of an organization, as well as an architecture comprising means for the implementation of such a process.

In particular, the organization may be a company, but also an association.

The process provides for generating a pair of private 9a and public 9b keys to allow the user 1, 1a, 1b, 1c, 1d to carry out cryptographic signatures during a participation in an operational function in the blockchain.

In particular, the process provides for generating the pair of keys 9a, 9b in a terminal 3 of the user 1, 1a, 1b, 1c, 1d under the control of said user.

Therefore, the private key 9a never leaves the terminal 3 of the user 1, 1a, 1b, 1c, 1d, which guarantees optimum confidentiality to said user.

For this purpose, the architecture comprises an application which is installed on the terminal 3 of the user 1, 1a, 1b, 1c, 1d, said application comprising means for creating such keys 9a, 9b under the control of said user.

In the figures, the terminal 3 is a smart mobile phone (“smartphone”). The terminal 3 may also be a digital tablet, or else a personal assistant (PDA, standing for “Personal Digital Assistant”).

The process also provides for collecting personal data of the user 1, 1a, 1b, 1c, 1d, said data comprising at least one information item on the identity of said user and one information item on said organization.

In particular, the information item on the identity of the user 1, 1a, 1b, 1c, 1d may include nominative information, for example the name and/or first name of said user. Moreover, the information item on the organization may comprise a registration identifier of said organization before a judicial or legal authority, such as for example a SIREN (standing for “Systéme d′Identification du Repertoire des Entreprises”, which is the French Business Register Identification System) number.

The architecture comprises a central platform 2 which comprises means for collecting such personal data, as well as means for collecting the public key 9b of the user 1, 1a, 1b, 1c, 1d.

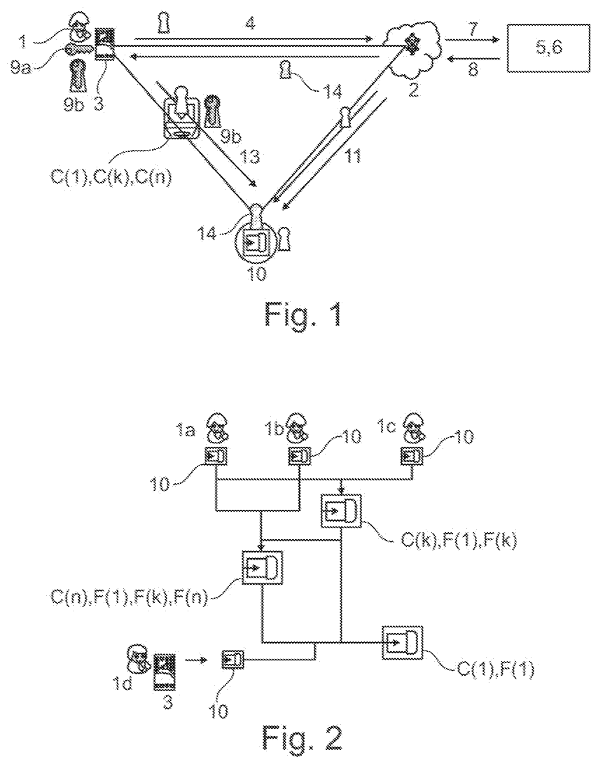

Referring to FIG. 1, the user 1 sends by means of his terminal 3 at least one message 4 comprising the required personal data and/or the public key 9b, the central platform 2 being arranged so as to receive said message(s) and extracting therefrom said data and said public key thanks to suitable collection means.

In particular, sending of personal data may be performed by means of a security system, such as for example the Safekey® system developed by the company American Express®, which provides for communicating to the terminal 3 a single-use identifier that the user 1, 1a, 1b, 1c, 1d must enter to enable said sending, or still systems based on a TLS (standing for “Transaction Secure Layer”) cryptographic process.

Afterwards, the process provides for verifying the validity of the collected personal data, in particular for verifying that the user 1, 1a, 1b, 1c, 1d actually belongs to the organization.

For this purpose, the central platform 2 comprises means for performing such a verification. In particular, the central platform 2 can interact with a database in which the identities of all members of the organization are registered, in order to verify the validity of the collected data according to the presence or not of the identity information of the user 1, 1a, 1b, 1c, 1d in said database.

Advantageously, the process may also verify a confidence level of the collected personal data, in order to validate them only if said level corresponds at least to a predetermined minimum level.

Afterwards, the process provides for identifying a status of the user 1, 1a, 1b, 1c, 1d within the organization by means of the verified data, the central platform 2 comprising means adapted to carry out such an identification.

In particular, the process provides for identifying this status by verifying the presence of the identity information collected in a legal digital register 5 of the managers of the organization, said register being selected by means of the information item collected on said organisation.

For this purpose, the identification means of the central platform 2 are arranged so as to interact with a platform 6 for providing legal digital registers of several organizations, for example by means of a suitable programming interface (API, standing for “Application Programming Interface”), to:
select the digital register 5 of the managers of the organization by means of the information item collected on said organization; and
verify the presence of the collected identity information in said register.

For example, the platform 6 may be the Datainfogreffe® platform of the Clerks of the Commercial Courts, in which companies are registered with their SIREN number.

Referring to FIG. 1, the central platform 2 sends to the registry platform 6 a request 7 comprising the information item collected on the organization, the platform 6 sending in return a message 8 comprising the list of managers of said organization extracted from the corresponding register 5, in order to enable the status identification means to verify the presence of the user 1 identity information in said list.

In particular, the identity information of the managers of the organization may be registered in the digital register 5 according to n categories, n being a natural number greater than or equal to 2, depending on the position occupied by each of said managers. Thus, the register 5 may include a category n grouping together the senior managers, for example the Chief Executive Officer (CEO) or the Director-General (DG) of a company, as well as at least one category n-1 grouping together the middle managers, for example the members of the Board of Directors of the company.

In this case, the process may provide for identifying the status of the user 1, 1a, 1b, 1c, 1d by determining his level of importance k, k being a natural number comprised between 1 and n, depending on the possible category with which his identity information is registered in the register 5. For this purpose, the identification means of the central platform 2 may be arranged so as to determine such a level of importance k for the user 1, 1a, 1b, 1c, 1d.

And, in the event of absence of the identity information of the user 1, 1a, 1b, 1c, 1d in the register 5, in particular in the case of an employee of the organization not belonging to the managers, the process may provide for determining for said user a minimum level of importance 1, in order to enable him to access the blockchain, but with limited possibilities of action.

Once the status of the user 1, 1a, 1b, 1c, 1d has been identified, the process provides for registering the public key 9b in at least one digital safe C(1), C(k), C(n) of the blockchain according to said identified status, in order to allow said user to participate in at least one operational function in the blockchain accessible via said safe.

For this purpose, the architecture comprises a platform 10 for providing at least one digital safe C(1), C(k), C(n) allowing participation in an operational function F(1), F(k), F(n) in the blockchain, the central platform 2 comprising means for registering the public key 9b in at least one of said safes according to the status identified for the user 1, 1a, 1b, 1c, 1d.

In particular, the digital safe platform 10 may comprise means for creating a digital safe C(1), C(k), C(n) in the form of a smart contract type (“Smart contract”) computer protocol, said smart contract being accessible to the user 1, 1a, 1b, 1c, 1d by means of a public digital address 14.

Advantageously, the blockchain comprises n digital safes C(1), C(k), C(n) providing access to a set F(1), F(k), F(n) of operational functions, the process providing for registering the public key 9b of the user 1, 1a, 1b, 1c, 1d in at least one of these safes C(1), C(k), C(n) according to its determined level of importance k.

For this purpose, the safe platform 10 comprises n digital safes C(1), C(k), C(n) as described before, the registration means of the central platform 2 being arranged so as to register the public key 9b in at least one of these safes C(1), C(k), C(n) according to the level of importance k determined for the user 1, 1a, 1b, 1c, 1d.

In particular, for a user 1, 1a, 1b, 1c, 1d present on the register 5, the process provides for registering the public key 9b in each safe C(1), C(k), in order to be able to participate in all sets F(1), F(k) of operational functions corresponding to its level of importance k.

And, in the absence of identity information of the user 1, 1a, 1b, 1c, 1d in the digital register 5, the process provides for registering the public key 9b in a digital safe C(1) for participating in standard operational functions F(1) of the organization.

For this purpose, the registration means of the central platform 2 are arranged so as to register the public key 9b in such a safe C(1).

Referring to FIG. 2, the users 1a, 1b, 1c, whose status in the organization has a level of importance comprised between 2 and n because of their presence on the register 5, all have access to k sets F(1), F(k) of operational functions in the blockchain, k designating the lowest level of importance amongst those of said users.

However, only two users 1a, 1b, because of their maximum level of importance n, have access to the set F(n) grouping together the most important operational functions, for example relating to the appointment of executive managers for the organization.

Thus, the most important users 1a, 1b, for example the Chief Executive Officer (CEO) and the Director-General (DG) of a company, can connect to the blockchain through all safes C(1), C(k), C(n) of the blockchain, in order to be able to participate in all sets F(1), F(k), F(n) of operational functions available in said blockchain.

Similarly, the third user 1c, for example a member of the Board of Directors of the company, can connect to the blockchain only through the safes C(1), C(k), in order to be able to participate in the operational functions F(1), F(k) available for his level of importance k.

Finally, the user 1d, whose status has a minimum level of importance 1 because of his absence from register 5, has only access to a set F(1) of standard operational functions, and therefore can only connect to the blockchain through the corresponding safe C(1).

A safe C(1), C(k), C(n) may be programmed to enable the validation of an operational function F(1), F(k), F(n) only in case of agreement of a given number of users 1, 1a, 1b, 1c, 1d of said safe. Thus, optimum security is guaranteed as to the consent of the participants eligible for the most important operational functions, for example the voting sessions of the Board of Directors of a company.

In particular, each public key 9b may be registered in the platform 10 with a level of security which corresponds to the level of importance k of its user 1, 1a, 1b, 1c, 1d, the risk of fraudulent use of said public key being all the more reduced as its level of security is high. As example, the risk of fraudulent use of a public key 9b may be represented by a numerical value comprised between 0 and 1.

Thus, a reduced risk of infringement is guaranteed during each operational function F(1), F(k), F(n) carried out by means of the blockchain, to the extent that such a risk, which could be calculated by considering the product of the risks of fraudulent use of the keys 9b of each participant and the risk of fraudulent use of the platform 2, will always has a lower value than that of the lowest risk amongst those of said participants and of said platform.

For example, if the platform 2 has a medium risk of fraudulent use and that, amongst the participants, the lowest risk level is also average, then the risk of infringement during the completion of the operational function F(1), F(k), F(n) will be average.

Similarly, if the platform 2 has a minimum risk of fraudulent use and, amongst the participants, the lowest level of risk is also minimum, then the risk of infringement during the completion of the operational function F(1), F(k), F(n) will be minimum.

Furthermore, given the aforementioned mathematical principle, it is also possible to obtain a minimum risk of infringement with participants with average and/or higher risk values.

Referring to FIG. 1, after the generation of the keys 9a, 9b and the determination of the level of importance k of the user 1, 1a, 1b, 1c, 1d, the central platform 2 sends to the platform 10 a message 11 comprising the public key 9b of said user, in order to enable the platform 10 to register it in the corresponding safe(s) C(1), C(k), C(n).

The process may also provide for communicating to the user 1, 1a, 1b, 1c, 1d a link for accessing the safe C(1), C(k), C(n), in particular the digital address 14 of said safe, in parallel with the registration of his public key 9b. For this purpose, the central platform 2 comprises means for performing such a communication, for example by sending to the terminal 3 a message 12 comprising such a link 14.

The link 14 may be arranged, when a user 1, 1a, 1b, 1c, 1d activates it, to enable the display on the terminal 3 of said user of a user interface enabling him to send his public key 9b to the platform 10, in particular through a message 13, in order to access the safe C(1), C(k), C(n) corresponding to the operational function F(1), F(k), F(n) in which he wishes to participate.

What is claimed is:

1. A process for allowing a user to access a blockchain of an organization, the process providing for:
generating a pair of a private key and a public key to allow the user to carry out cryptographic signatures during a participation in an operational function in the blockchain;
collecting personal data of the user, the data comprising at least one information item on the identity of the user and one information item on the organization;
verifying the validity of the personal data;
identifying a status of the user within the organization using verified data;
registering the public key in at least one digital safe of the blockchain according to the identified status of the user, in order to allow the user to participate in at least one operational function in the blockchain accessible via the safe.

2. The process according to claim 1, characterised in that it provides for wherein the status of the user is identified by verifying the presence of the identity information collected in a digital legal register of the managers of the organization, the register being selected by the information item collected on the organization.

3. The process according to claim 2, wherein the identity information of managers of the organization are registered in the digital register according to n categories, n being a natural number greater than or equal to 2, the process providing for identifying the status of the user by determining his level of importance k, k being a natural number between 1 and n, depending on the possible category with which the identity information is registered in the register.

4. The process according to claim 3, wherein the blockchain comprises n digital safes providing access to a set of operational functions, the process providing for registering the public key of the user in at least one of these safes depending on its determined level of importance k.

5. The process according to claim 4, wherein in the absence of identity information of the user in the digital register, registering the public key of the user in a digital safe for participating in standard operational functions of the organization.

6. The process according to claim 1, providing for communicating to the user a link for access to the safe in parallel with the registration of his public key in the safe.

7. An architecture for allowing a user to access a blockchain of an organization, the architecture comprising:
an application installed on a terminal of the user, the application comprising a generator for generating a pair of private and public keys to allow the user to carry out cryptographic signatures during a participation in an operational function in the blockchain;
a platform for providing at least one digital safe allowing participation in an operational function in the blockchain;
a central platform comprising:
a key collector for collecting the public key;
a personal data collector for collecting personal data of a user, the personal data comprising at least one information item on the identity of the user and one information item on the organization;
verifier for verifying the validity of the personal data;
identifier for identifying a status of the user within the organization using the verified data;
register for registering the public key in at least one digital safe according to the identified status, in order to allow the user to participate in at least one operational function in the blockchain accessible via the safe.

8. The architecture according to claim 7, wherein the identifier is arranged to interact with a platform for providing legal digital registers of several organizations for:
selecting the digital register of managers of the organization using the information item collected on the organization; and
verifying the presence of the collected identity information in the register.

9. The architecture according to claim 8, wherein the identity information of managers of the organization is registered in the digital register according to n categories, n being a natural number greater than or equal to 2, the identifyer being configured to identify the status of the user by determining his a level of importance k, k being a natural number comprised between 1 and n, depending on the possible category with which identity information is registered in the register.

10. The architecture according to claim 9, wherein the safe platform comprises n digital safes providing access to a set of operational functions, the digital register being arranged to register the public key of the user in at least one of these safes according to its determined level of importance k.

11. The architecture according to claim 10, wherein the digital register is arranged, in the absence of the identity information of the user in the digital register, to register the public key of the user in a digital safe for participating in standard operational functions of the organization.

12. The architecture according to claim 7, wherein the central platform comprises a communicator for communicating to the user a link for accessing the safe in parallel with the registration of his public key.
